(19) United States
(12) Patent Application Publication
(10) Pub. No.: US 2025/0278557 A1
(43) Pub. Date: Sep. 4, 2025

(54) QUERY EXECUTION METHOD FOR ELECTRONIC FORM COMPLETION

(71) Applicant: Intuit Inc., Mountain View, CA (US)

(72) Inventors: Surya Kiran MUNUKUTLA, San Diego, CA (US); Sangeetha Uthamalingam SANTHARAM, San Diego, CA (US)

(73) Assignee: Intuit Inc., Mountain View, CA (US)

(21) Appl. No.: 18/592,461

(22) Filed: Feb. 29, 2024

(51) Int. Cl. G06F 40/174; G06F 16/2455; G06F 16/25; G06F 40/30

(52) U.S. Cl. CPC G06F 40/174; G06F 16/24556; G06F 16/258; G06F 40/30

(57) ABSTRACT

A method including receiving a user query relating to completion of an electronic form stored as a data object. A context topic is generated that describes a category of data relevant to the user query. Data sets that correspond to the context topic are extracted. A machine learning model is applied to the user query and the data sets to generate a prediction text representing a predicted intent of the user. A subset of rules and a data schema are generated by applying the prediction text and the data sets to a data file including rules and data schema applicable to the rules. A subset of the data sets is determined based on the subset of rules. The subset of rules is applied to the subset of the data sets to generate the output data object. The output data object is returned.

### BACKGROUND

Proper completion of complex electronic forms can be difficult, particularly when the complex electronic forms interact with each other. For example, tax preparation software may use multiple, interacting electronic forms to aid a user in preparing the user's taxes. However, when an error occurs in the forms, it may not be apparent where the error is located, what information is missing, or how an error was introduced into the electronic form, etc.

In most cases, the error is a user error. However, regardless of how an error arose, a user may become frustrated with an error returned when the software processes an electronic form. A frustrated user may seek help to correct the error or may seek help in understanding or completing an electronic form. Thus, having a system to automatically identify and correct the source of the user's error or problem, and thereby automatically correct or complete the electronic form, would be useful.

A frustrated user may also turn to a subject matter expert for help correcting the error or for help completing the electronic form. Alternately, a frustrated user may not know which form to use to perform a particular activity, and so turn to the subject matter expert for help finding and processing the correct form. However, a subject matter expert would have to start from scratch in order to understand the user's particular situation before beginning to solve the user's specific problem. In an example, while a subject matter expert may have access to the user's specific data, the subject matter expert may not understand other customer context or may not understand customer intent, and thus spend valuable time trying to identify a form the user needs or the user's specific problem with a particular form. Thus, having a system for identifying a likely source of the user's problem with the electronic form, and automatically presenting to the subject matter expert possible solutions to the user's problem with the electronic form, would also be useful.

### SUMMARY

One or more embodiments provide for a method. The method includes receiving a user query of a user. The user query relates to completion of an electronic form stored as a data object. The method also includes generating a context topic that describes a category of data relevant to the user query. The method also includes extracting data sets that correspond to the context topic. The method also includes applying a machine learning model to the user query and the data sets to generate a prediction text representing a predicted intent of the user. The method also includes applying, to generate a subset of rules and a data schema, the prediction text and the data sets to a data file including rules and data schema applicable to the rules. The subset of rules is included in the rules and the data schema is included in the data schema. The data schema defines an output format of an output data object generated when the subset of rules is executed. The method also includes determining, based on the subset of rules, a subset of the data sets. The method also includes applying the subset of rules to the subset of the data sets to generate the output data object. The output data object is formatted according to the data schema. The output data object describes information that is both related to completion of the electronic form and relevant to the predicted intent. The method also includes returning the output data object.

One or more embodiments provide for another method. The method includes receiving, from an end user, a user query regarding completion of an electronic form stored as a data object. The method also includes generating a context topic that describes a category of data relevant to the user query. The method also includes extracting, from disparate data sources, data sets that correspond to the context topic. The method also includes applying a machine learning model to the user query and the data sets to generate a prediction text representing a predicted intent of the end user. The method also includes applying, to generate a subset of rules and a data schema, the prediction text and the data sets to a data file including rules and data schema applicable to the rules. The subset of rules is included in the rules and the data schema is included in the data schema. The data schema defines an output format of an output data object generated when the subset of rules is executed. The method also includes determining, based on the subset of rules, a subset of the data sets. The method also includes applying the subset of rules to the subset of the data sets to generate the output data object. The output data object is formatted according to the data schema. the output data object describes information that is both related to completion of the electronic form and relevant to the predicted intent. The method also includes generating a user interface using the output data object. The method also includes presenting the user interface on a display device of a helper user. The method also includes establishing a communication link between the helper user and the end user.

One or more embodiments also provide for a system. The system includes a computer processor and a data repository in communication with the computer processor. The data repository stores a user query of a user, the user query relating to completion of an electronic form stored as a data object. The data repository also stores a context topic that describes a category of data relevant to the user query. The data repository also stores data sets that correspond to the context topic. The data repository also stores a prediction text representing a predicted intent of the user. The data repository also stores a data file including rules and data schema applicable to the rules. The data repository also stores a subset of rules and a data schema. The subset of rules is included in the rules and the data schema is included in the data schema. The data schema defines an output format of an output data object generated when the subset of rules is executed. The data repository also stores a subset of the data sets. The data repository also stores the output data object. The output data object is formatted according to the data schema and the output data object describes information that is both related to completion of the electronic form and relevant to the predicted intent. The system also includes an orchestration service programmed, when executed by the computer processor, to receive the user query. The orchestration service is also programmed to generate the context topic based on the user query. The orchestration service is also programmed to extract the data sets from disparate data sources. The orchestration service is also programmed to return the output data object. The system also includes a machine learning model trained, when executed by the computer processor, to predict the prediction text from the user query and the data sets. The system also includes a runtime platform programmed, when executed by the computer processor, to apply the prediction text and the data sets to the data file to generate the subset of rules and the data schema. The runtime platform is also programmed to determine, based on the subset of rules, the subset of the data sets. The runtime platform is also programmed to apply the subset of rules to the subset of the data sets to generate the output data object.

Other aspects of one or more embodiments will be apparent from the following description and the appended claims.

### BRIEF DESCRIPTION OF DRAWINGS

FIG. 1A and FIG. 1B shows a computing system, in accordance with one or more embodiments.

FIG. 2 shows a flowchart of a method for an improved query execution method for electronic form completion, in accordance with one or more embodiments.

FIG. 3 shows an alternative architecture for an improved query execution method for electronic form completion, in accordance with one or more embodiments.

FIG. 4 shows an example of an improved query execution method for electronic form completion, in accordance with one or more embodiments.

FIG. 5A and FIG. 5B show a computing system and network environment, in accordance with one or more embodiments.

Like elements in the various figures are denoted by like reference numerals for consistency.

### DETAILED DESCRIPTION

One or more embodiments are directed to an improved query execution method for electronic form completion. One or more embodiments may gather user data from multiple disparate data sources and, from the gathered data, extract a context or intent of the user. One or more embodiments also may identify any errors in the electronic form based on what actions the user may have taken with respect to the electronic form.

One or more embodiments then determine which rules may apply to the extracted context. The rules are applied to the user's specific situation, and a result is returned. The result may be to complete the electronic form automatically. The result may be to present a subject matter expert with the user's context, query, and other information so that the subject matter expert may help the user more effectively and more quickly.

Thus, one or more embodiments may proceed in three phases: a data aggregation phase, a data processing and validation phase, and a guidance phase. In the data aggregation phase, the user query and a context topic generated based on the user query are used to extract data sets that correspond to the user's intent and the user's problem with an electronic form.

In the data processing and validation phase, rules, and a data schema specific to the form may be created from the selected data and the user intent. Then, a subset of available data is selected based on the rules in order to identify the electronic form to be processed and the rules for processing the electronic form. Then, the subset of rules is applied to the subset of data to generate an output data object. The output data object is formatted according to the schema and described information that is both related to completion of the electronic form and to the predicted intent of the user.

During the guidance phase, the output data object is applied to address the user's issues. If the user wanted help directly completing the electronic form, the output data object may be applied to the electronic form in order to complete, at least partially, the electronic form. If the user had asked for help from a subject matter expert, then the output data object may be configured to present information on a user interface of the subject matter expert's display device. The information is related to the user's problem and may provide suggestions to the subject matter expert to address the user's likely concerns or may suggest specific solutions to the user's problems with the electronic form (including which electronic form to use).

Thus, one or more embodiments present a method of improving the functioning of a computer by providing a method of generating an output data object that has a schema and the information that is desired for a wide variety of different problems related to handling electronic forms. The output data object created at each user query may be flexible and thereby useful to each unique user because the output data object may be specifically constructed for a particular user's issues with an electronic form, which may include determining which electronic form to use in the first place. In other words, one or more embodiments may be characterized as an improved query execution method for electronic form completion.

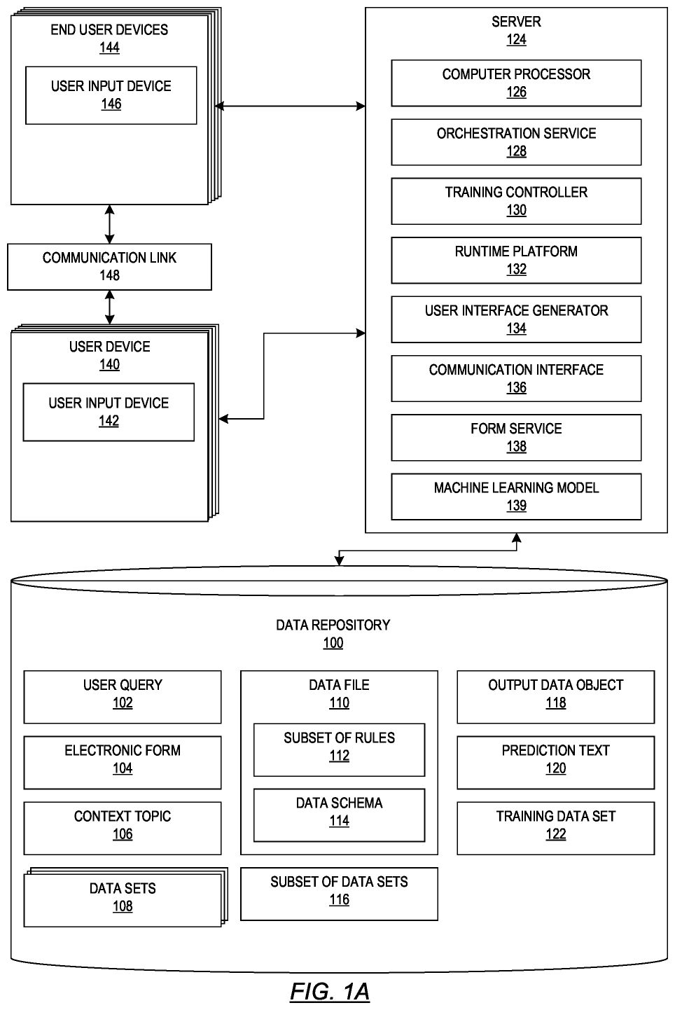

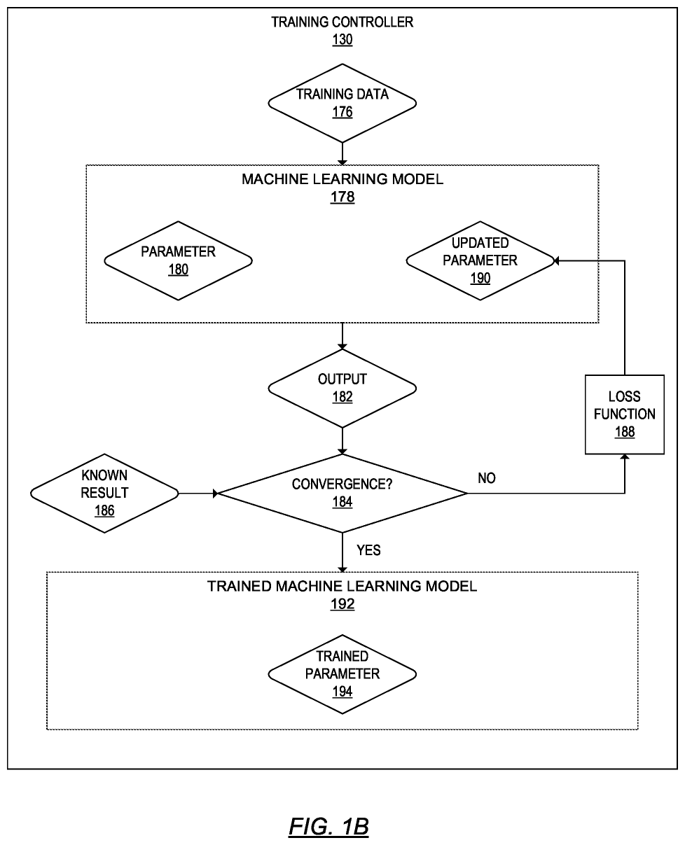

Attention is now turned to the figures. FIG. 1A shows a computing system, in accordance with one or more embodiments. The system shown in FIG. 1A includes a data repository (100). The data repository (100) is a type of storage unit or device (e.g., a file system, database, data structure, or any other storage mechanism) for storing data. The data repository (100) may include multiple different, potentially heterogeneous, storage units and/or devices.

The data repository (100) may store a user query (102). The user query (102) is an electronic message received from a user. The user query (102) may take the form of a text query submitted by a user. The user query (102) may take the form of the activation of a widget on a user interface of a user device. The user query (102) may include additional information the user supplies after the user submits a query or a request for help, such as by user-supplied information in response to a prompt displayed to the user.

The data repository (100) also may store an electronic form (104). The electronic form (104) is a data structure storing information defining an electronic form. The data structure may take a variety of different forms, including object notation data formats, relational databases, a hypertext markup language file, etc. However, the data structure of the electronic form (104) may be processed so that a user may use a computer to manipulate the electronic form to accomplish some function or result. Examples of electronic forms include, but are not limited to, tax forms, business forms, surveys, etc.

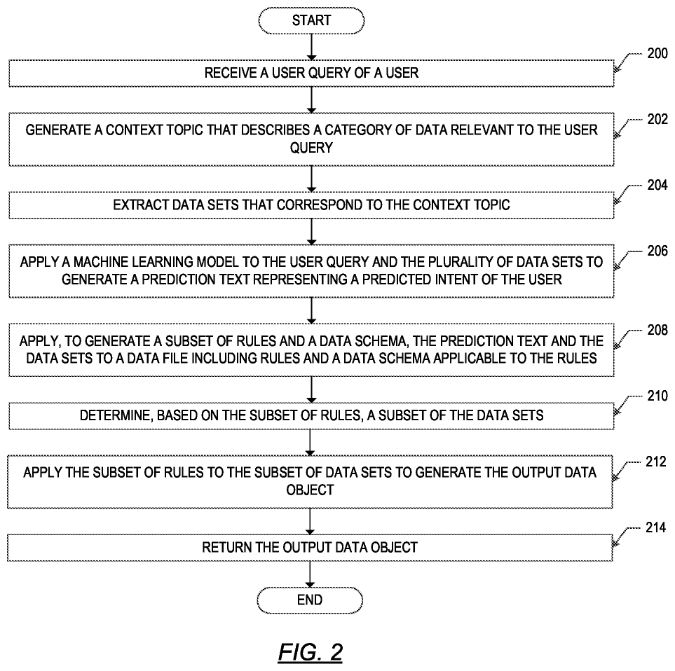

The data repository (100) also may store a context topic (106). The context topic (106) is a data file that stores information that describes a category of data relevant to the user query. For example, the context topic (106) may be a data file that indicates that the category of data of concern to the user is a particular set of tax forms or may be information about a particular area of scientific research for which electronic forms are to be prepared. The context topic may be generated based on the user query, as described with respect to FIG. 2.

The data repository (100) also may store or more data sets (108). The data sets (108) need not have been immediately available in the data repository (100). For example, the data sets (108) may include third-party data which is extracted from one or more disparate sources of data. Thus, the data sets (108) may be disparate, i.e., stored in a variety of different format and be information about many different subjects. However, the data sets (108) may be relevant to the context topic. Thus, the data sets (108) may be accessed or identified based on the specific user query (102) submitted by the user.

The data repository (100) also may store a data file (110). The data file (110) is a computer-usable library. Specifically, the data file (110) stores many different rules and different schema which may be applicable to the rules and to the format of any data output by the different rules. The data file (110) may include a vast number of rules and data schema, not all of which may be relevant to the user query (102). In a specific example, the data file (110) may take the form of a spreadsheet that stores rules, data sources applicable to the rules, and data schema that define the data schema of any output generated by the stored rules. Use of the data file (110) is described with respect to FIG. 2.

The data file (110) may store a subset of rules (112). The subset of rules (112) is a selected number of the rules in the data file (110), but theoretically may include all of the rules in the data file (110). The subset of rules (112) is relevant to the user query (102). For example, the subset of rules (112) may be rules relating to error checking and rules for completing a specific form identified based on the user query (102). Determination of the subset of rules (112) is described with respect to FIG. 2.

The data file (110) also may store a data schema (114). The data schema (114) is a format for storing data in a computing system. Examples of data schema include object notation data formatting, hypertext markup language format, plain text format, dynamically linked libraries (DLLs), and many other different computer-readable data formats. The data schema (114) may be selected for use with the subset of rules (112) based on the user query (102). Use of the data schema (114) is described with respect to FIG. 2.

The user query (102) also may store a subset of data sets (116). The subset of data sets (116) is one or more of the data sets (108), or selected portions of a particular set of data selected from the data sets (108). The subset of data sets (116) is relevant to the user query (102). Generation and use of the subset of data sets (116) is described with respect to FIG. 2.

The user query (102) also may store an output data object (118). The output data object (118) is a computer-readable data object that is output by the subset of rules (112) or is generated from the output of the subset of rules (112). The output data object (118) may include computer executable code, data, and other information for responding to the user query (102). For example, the output data object (118) may be code and data for automatically completing an electronic form. The output data object (118) may be instructions for generating a user interface to present to a subject matter. The user interface in example may then display information pertaining to the ‘user query (102), including recommended courses of action for the subject matter expert to take to assist the user with completing the electronic form.

The output data object (118) is thus flexible in the sense that a new data object may be generated for each user query (102). In this manner, each user's unique user query (102) may be handled in a manner to solve the user's specific problem with an electronic form. However, it is also possible to store one or more output data objects for later use. For example, a commonly received user query (e.g., please automatically prepare Electronic Form 1090) may be processed by retrieving a pre-prepared version of the output data object (118).

The user query (102) also stores a prediction text (120). The prediction text (120) is text output by a machine learning model, such as a large language model or some other prediction or classification machine learning model. The prediction text (120) may be stored in the form of text file or may be stored in a vector format suitable for input to or output from a machine learning model. The prediction text (120) may be in a human-readable format in some cases. In any case, the prediction text (120) represents a machine-predicted intent of the user query (102). Examples of machine learning models that may be used to generate text that predict a user intent include large language models or other types of machine learning models.

The user query (102) also may store a training data set (122). The training data set (122) is data stored in a vector data format for use as input to a machine learning model. However, due to past knowledge, if a machine learning model is executed when using the training data set (122) as input, then the correct answer to the output is known. For example, the training data set (122) may include data for a past user query for which it was known that the user's intent was to identify an electronic form. Thus, when the training data set (122) is input to a machine learning model, then the prediction text (120) should accurately correspond to the user's actual intent to identify the electronic form. The training data set (122) is used when training a machine learning model, as described with respect to FIG. 1B.

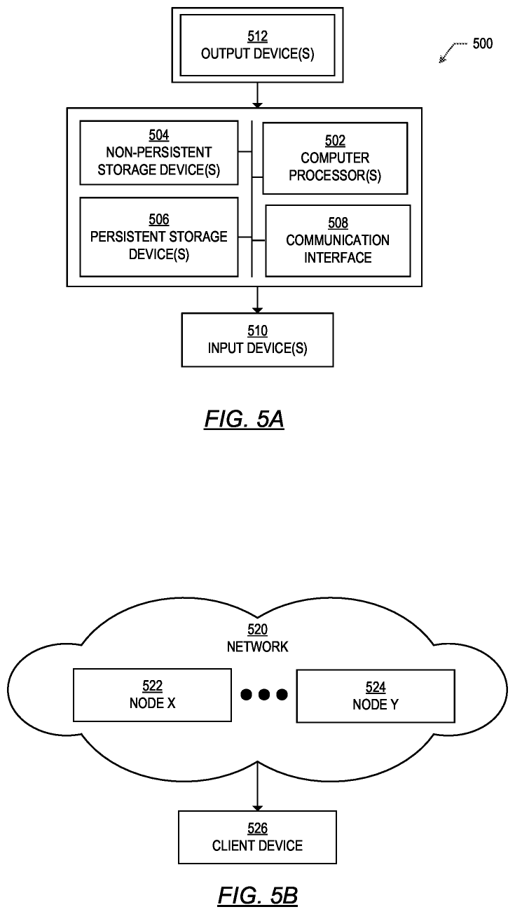

The system shown in FIG. 2 also may include a server (124). The server (124) is a computing system, possibly executing in a distributed computing environment. The server (124) may be, for example, the computing system and network environment shown in FIG. 5A and FIG. 5B.

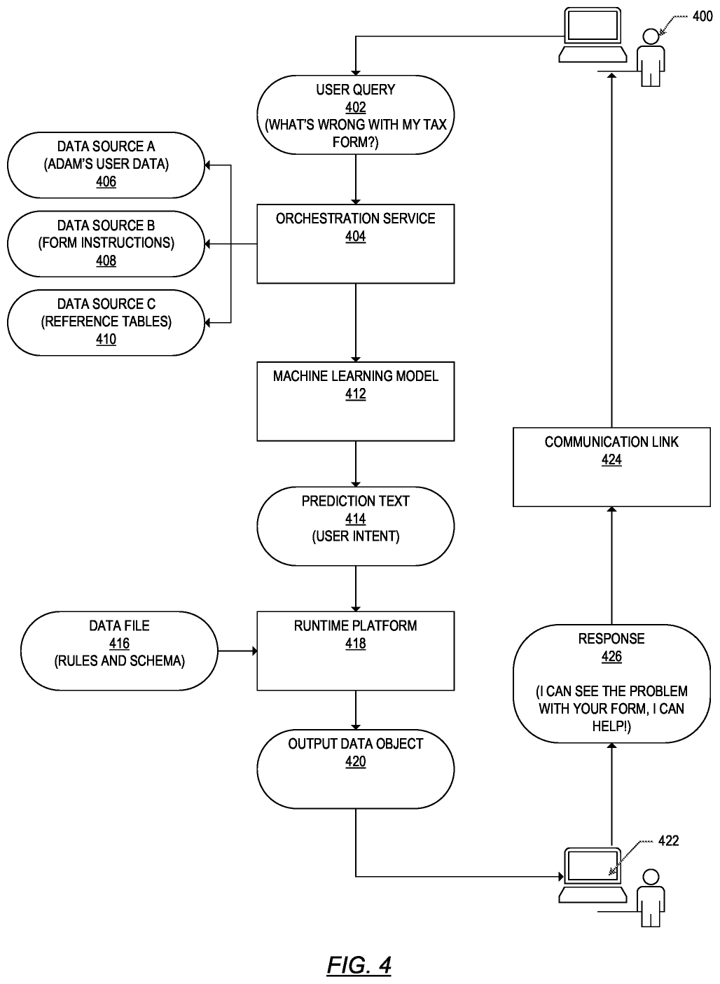

The server (124) includes a computer processor (126). The computer processor (126) is one or more hardware or virtual computer processors. The computer processor (126) may execute computer readable program code that embody the instructions that are reflected in the method of FIG. 2 or the example of FIG. 4.

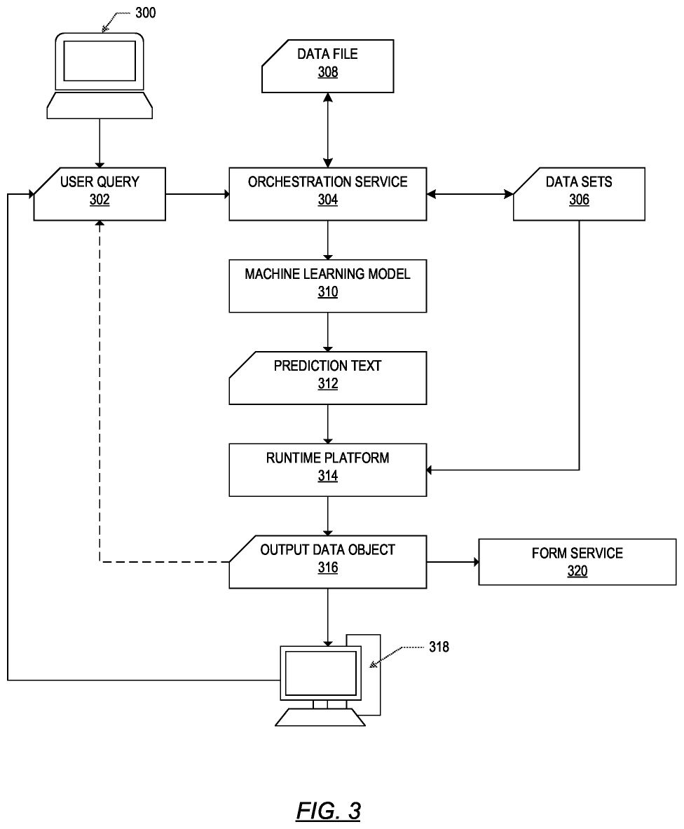

The server (124) also may include an orchestration service (128). The orchestration service (128) is a set of computer hardware or software which is programmed to gather and distribute data. For example, the orchestration service (128) may be programmed to receive the user query (102), generate the context topic (106) based on the user query (102), extract the data sets (108), and return the output data object (118). Examples of the orchestration service (128) are shown in FIG. 3 and in FIG. 4.

The server (124) may also include a training controller (130). The training controller (130) is software or hardware programmed to train a machine learning model, such as the machine learning model (139), described below. The operation of the training controller (130) is described with respect to FIG. 1B.

The server (124) also may include a runtime platform (132). The runtime platform (132) is hardware or software which is programmed to manipulate and apply the data file (110). For example, the runtime platform (132) may apply the prediction text and the data sets to the data file to generate the subset of rules (subset of rules (112)). The runtime platform (132) may also determine the subset of data sets (116). The runtime platform (132) also may apply the subset of rules (112) to the subset of data sets (116) to generate the output data object (118). Examples of the runtime platform (132) are shown in FIG. 3 and FIG. 4.

The server (124) also may include a user interface generator (134). The user interface generator (134) is software or hardware programmed to generate a user interface, based on the instructions contained in the output data object (118). For example, the user interface generator (134) may be programmed to generate text or widgets for presentation to a user or to an end user device (i.e., the user device of a subject matter expert). Examples of the user interface generator (134) are shown in FIG. 3 and FIG. 4.

The server (124) also may include a communication interface (136). The communication interface (136) is software or hardware that permits two or more computing systems to communicate with each other. For example, the communication interface (136) may include communication ports, routers, and data protocol stacks for permitting computers to communicate with each other.

The server (124) also may include a form service (138). The form service (138) is software or hardware programmed to manipulate an electronic form. For example, a form service (138) may take data received from a user and use that data to populate an electronic form. The form service (138) may scan physical forms provided by a user, extract information from scanned forms, access remote data sources, etc., and use the resulting information to complete an electronic form or to display information to the user about the electronic form.

The server (124) also may include a machine learning model (139). The machine learning model (139) is software or hardware which, when executed by the computer processor (126), finds hidden patterns in data. Specifically, the machine learning model (139) is programmed to output the prediction text (120), defined above, when the user query (102) is provided as input to the machine learning model (139).

The machine learning model (139) may be a large language model. A large language model (LLM) is a type of artificial intelligence (AI) algorithm that uses deep learning techniques and massively large data sets to understand, summarize, generate, and predict new content. The term generative AI also is closely connected with LLMs, which are, in fact, a type of generative AI that has been specifically architected to help generate text-based content.

However, the machine learning model (139) may be other types of machine learning models. For example, the machine learning model (139) may be some other kind of natural language processing model. Thus, the machine learning model (139) is not limited to a large language model.

The system shown in FIG. 1A may interact with other systems, which are represented in FIG. 1A for convenience. Thus, the system of FIG. 1A may interact with a user device (140) or one or more end user devices (144), which may communicate with each other via a communication link (148). In many cases, the user device (140) or the end user devices (144) are not part of a system owned or operated by the entity that owns or operates the server (124). Such devices may be referred to as “remote” devices. However, the end user devices (144), user device (140), or both may be part of the same system of which the server (124) is a part. In this case, such devices may be referred to as “local” devices, even if the devices are not in the same physical geographical location.

With the above description in mind, FIG. 1A shows a user device (140). The user device (140) is the computing system which a user uses to submit the user query (102) via a user input device (142). The user input device (142) is a mouse, keyboard, microphone, touch screen, haptic device, etc., with which the user may interact with the user device (140).

FIG. 1A also shows one or more end user devices (144), each of which also includes a user input device (146) with which an end user may interact with the end user devices (144). The end user devices (144) are devices used by some other user, other than the user, that submitted the user query (102). For example, the end user devices (144) may be one or more computing systems used by one or more subject matter experts that are available to assist the user of the user device (140) to complete an electronic form.

The term “end user” is used to distinguish between the user who submits the user query (102) and the user who assists that user. The term “end user” may be useful, as in some embodiments the system of FIG. 1A and the method of FIG. 2 may be designed to generate suggestions for helping the user that generated the user query (102). Such suggestions are meant for the use of the subject matter expert who uses one of the end user devices (144).

Thus, for example, FIG. 1A also shows a communication link (148) between the user device (140) and the end user devices (144). In an embodiment, one of the functions of the output data object (118) may be to provide instructions for establishing the communication link (148) via the communication interface (136) between the user device (140) and an appropriate one of the end user devices (144). In this manner, the user device (140) may communicate with one of the end user devices (144) operated by a subject matter expert selected to assist the user who submitted the user query (102). In this particular example, the output data object (118) also may provide instructions to one of the end user devices (144) to display electronic form information and suggestions to a subject matter expert for assisting the user who submitted the user query (102). Note, however, that such an example is not limiting, because the output data object (118) also may be used to provide instructions to the form service (138) to automatically complete an electronic form for the user of the user device (140).

Attention is turned to FIG. 1B, which shows the details of the training controller (130). The training controller (130) is a training algorithm, implemented as software or application specific hardware, that may be used to train one or more of the machine learning models described with respect to the computing system of FIG. 1A.

In general, machine learning models are trained prior to being deployed. The process of training a model, briefly, involves iteratively testing a model against test data for which the final result is known, comparing the test results against the known result, and using the comparison to adjust the model. The process is repeated until the results do not improve more than some predetermined amount, or until some other termination condition occurs. After training, the final adjusted model is applied to unknown data in order to make predictions.

Some machine learning models may be applied to vector data structures. A vector is a computer-readable data structure. A vector may take the form of a matrix, an array, a graph, or some other data structure. However, a frequently used form of vector is one by N matrix, where each cell of the matrix represents the value for one feature. A feature is a type of data (e.g., a color of an object, the presence of a word or alphanumeric text, a physical measurement type, etc.). A value is a numerical or other recorded specification of the feature. For example, if the feature is the word “cat,” and the word “cat” is present in a corpus of text, then the value of the feature may be “1” (to indicate a presence of the feature in the corpus of text).

In one or more embodiments, some of the data in the data repository (100) of FIG. 1A may be stored in the form of one or more vectors. For example, the training data set (122) may be one or more vectors.

Returning to the operation of the training controller (130), training starts with training data (176), and which may be expressed as a training data vector. The training data (176) may be the training data set (122) from FIG. 1A. The training data (176) may be data for which the final result is known with certainty. For example, if the machine learning task is to identify whether two names refer to the same entity, then the training data (176) may be name pairs for which it is already known whether any given name pair refers to the same entity.

The training data (176) is provided as input to the machine learning model (178). The machine learning model (178) may be characterized as a program that has adjustable parameters. The program is capable of learning and recognizing patterns to make predictions. The output of the machine learning model may be changed by changing one or more parameters of the algorithm, such as the parameter (180) of the machine learning model (178). The parameter (180) may be one or more weights, the application of a sigmoid function, a hyperparameter, or possibly many different variations that may be used to adjust the output of the function of the machine learning model (178).

One or more initial values are set for the parameter (180). The machine learning model (178) is then executed on the training data (176). The result is an output (182), which is a prediction, a classification, a value, or some other output which the machine learning model (178) has been programmed to output.

The output (182) is provided to a convergence process (184). The convergence process (184) is programmed to achieve convergence during the training process. Convergence is a state of the training process, described below, in which a pre-determined end condition of training has been reached. The pre-determined end condition may vary based on the type of machine learning model being used (supervised versus unsupervised machine learning) or may be pre-determined by a user (e.g., convergence occurs after a set number of training iterations, described below).

In the case of supervised machine learning, the convergence process (184) compares the output (182) to a known result (186). The known result (186) is stored in the form of labels for the training data. For example, the known result for a particular entry in an output vector of the machine learning model may be a known value, and that known value is a label that is associated with the training data.

Continuing the example of a supervised machine learning model training, a determination is made whether the output (182) matches the known result (186) to a pre-determined degree. The pre-determined degree may be an exact match, a match to within a pre-specified percentage, or some other metric for evaluating how closely the output (182) matches the known result (186). Convergence occurs when the known result (186) matches the output (182) to within the pre-determined degree.

In the case of unsupervised machine learning, the convergence process (184) may be compared to the output (182) or to a prior output in order to determine a degree to which the current output changed relative to the immediately prior output or to the original output. Once the degree of changes fails to satisfy a threshold degree of change, then the machine learning model may be considered to have achieved convergence. Alternatively, an unsupervised model may determine pseudo labels to be applied to the training data and then achieve convergence as described above for a supervised machine learning model. Other machine learning training processes exist, but the result of the training process may be convergence.

If convergence has not occurred (a “no” at the convergence process (184)), then a loss function (188) is generated. The loss function (188) is a program which adjusts the parameter (180) (one or more weights, settings, etc.) in order to generate an updated parameter (190). The basis for performing the adjustment is defined by the program that makes up the loss function (188), but may be a scheme which attempts to guess how the parameter (180) may be changed so that the next execution of the machine learning model (178) using the training data (176) with the updated parameter (190) will have an output (182) that is more likely to result in convergence. (E.g., that the next execution of the machine learning model (178) is more likely to match the known result (186) (supervised learning), or which is more likely to result in an output that more closely approximates the prior output (one unsupervised learning technique), or which otherwise is more likely to result in convergence.)

In any case, the loss function (188) is used to specify the updated parameter (190). As indicated, the machine learning model (178) is executed again on the training data (176), this time with the updated parameter (190). The process of execution of the machine learning model (178), execution of the convergence process (184), and the execution of the loss function (188) continues to iterate until convergence.

Upon convergence (a “yes” result at the convergence process (184)), the machine learning model (178) is deemed to be a trained machine learning model (192). The trained machine learning model (192) has a final parameter, represented by the trained parameter (194). Again, the trained parameter (194) shown in FIG. 1B may be multiple parameters, weights, settings, etc.

During deployment, the trained machine learning model (192) with the trained parameter (194) is executed again, but this time on unknown data (which may be in the form of an unknown data vector) for which the final result is not known. The output of the trained machine learning model (192) is then treated as a prediction of the information of interest relative to the unknown data.

While FIG. 1A and FIG. 1B show a configuration of components, other configurations may be used without departing from the scope of one or more embodiments. For example, various components may be combined to create a single component. As another example, the functionality performed by a single component may be performed by two or more components.

FIG. 2 shows a flowchart of a method for improved query execution method for electronic form completion, in accordance with one or more embodiments. The method of FIG. 2 may be executed using the system shown in FIG. 1.

Step 200 includes receiving a user query of a user. As described above, the user query relates to completion of an electronic form stored as a data object. The user query may be received by way of a communication interface. The user may submit the query in a dialog box presented on a display device of the user device, may be submitted by the activation of a widget on such a user device, or may be submitted in some other manner. The user query may take the form of text in most cases, though the user query may take the form of an image or an audio file in some cases. An example of receiving a user query is shown in FIG. 4.

Step 202 includes generating a context topic that describes a category of data relevant to the user query. As described above, the category of data is relevant to the section of the electronic form. The context topic may be generated by identifying a section of the electronic form related to the user query. The context topic then becomes information related to that section of the electronic form. The context topic may also be generated by applying a machine learning model to the user query, and predicting, as output of the machine learning model, the category of data relevant to the user query. The context topic may also be generated by identifying a name or other identifier of the electronic form, and then identifying data related to that name or identifier. Still other forms of generating the context topic are possible.

Step 204 includes extracting data sets that correspond to the context topic. The data sets may be extracted by identifying, based on the context topic, disparate data sources that contain the data sets. Then, one or more possibly separate application programming interface (API) calls may be made to the disparate data sources. As a result, the data sets are retrieved, either by accessing one or more of the data sources or by receiving data pushed by one or more of the data sources.

In an embodiment, at least a portion of the received data sets may be aggregated into a vector data structure. The portion of the received data sets may include, for example, identifiers or titles of the received data sets, but may include some of the data from the data sets. The vector data structure may be configured for use as input to a machine learning model.

In an embodiment, the machine learning model may be a large language model. In this case, the input to the machine learning model is natural language text. Thus, the identities of the extracted data sets, or some of the text from the data sets, may be provided as input to the large language model, as described below.

Step 206 includes applying a machine learning model to the user query and at least a portion of the data sets to generate a prediction text representing a predicted intent of the user. For example, step 206 may include converting the user query into a vector format and adding the user query to the vector data structure generated at step 204. Alternatively, the vector data structure generated at step 204 may be generated here at step 206. In either case, the vector data structure contains the information from both the user query and at least a portion of the data sets.

Applying the machine learning model is performed by providing the vector data structure as input to the machine learning model. A computer processor then executes the machine learning algorithm or algorithms that form the machine learning model. The output of the machine learning model is the prediction text.

Applying the machine learning model may also include generating a prompt. A prompt is a set of commands, system parameters, and other constraints that are placed on the execution of the machine learning model. The prompt may include the data sets (or the identifiers of the data sets) extracted at step 204. The user query may also form part of the text supplied to the large language model via the prompt.

Step 208 includes applying, to generate a subset of rules and a data schema, the prediction text and the data sets to a data file including rules and data schema applicable to the rules. The subset of rules is included in the rules and the data schema is included in the data schema. The data schema defines an output format of an output data object generated when the subset of rules is executed.

Applying the prediction text and the data sets to a data file may be performed by using the data sets (or the identifiers of the data sets) as search terms to search the data file. Applying the prediction text and the data sets to the data file may also be performed by applying rules or some other machine learning model to predict which rules in the data file are applicable to the prediction text and the data sets.

In a specific example, the data file may be a spreadsheet. In this case, applying the prediction text and the data sets to the data file further includes selecting, based on the prediction text and the data sets, the subset of rules from among the rules. For example, the prediction text and the data sets may indicate that certain rules applicable to the electronic form should be used. In addition, knowing the rules, or knowing the data sets or prediction text, the spreadsheet may specify the corresponding data schema or output format of the rules. An example of this procedure is shown in FIG. 4.

Step 210 includes determining, based on the subset of rules, a subset of the data sets. Specifically, the rules may be applied to determine exactly which data, among all the data sets, is of interest to solving the computing problem. For example, if the electronic form is a 1040-EZ tax form, and the user intent is to fill out the form, then the subset of data sets may include only the data to be used in filling out the form. In this case, such data may include the user's demographic and income information (e.g., a W-2 form supplied by the user).

By limiting the amount of data that is to be used, from among all possible data sets, the processing resources used to complete the method of FIG. 2 may be reduced. For example, searching the more limited data set takes less time, and reduces the chance that incorrect data will be retrieved for the electronic form in question.

Thus, for example, step 210 may include executing the subset of rules on the data sets to determine the subset of the datasets. Then, step 210 may include selecting the subset of the data sets based on identities of the subset of rules.

Step 212 includes applying the subset of rules to the subset of the data sets to generate the output data object. The output data object describes information that is both related to completion of the electronic form and relevant to the predicted intent. The output data object is formatted according to the data schema. For example, step 212 may include executing the subset of rules on input from the subset of the data sets to generate the content of the data object, and then formatting the data object according to the data schema. As a result, the data object contains the data useful for addressing the particular computing problem presented by the user's query, with that data being stored in a schema which is useful for the particular computing problem presented by the user's query.

For example, the subset of rules may be rules for filling out the electronic form automatically. In this case, the data in the data object is in the schema used by the electronic form, and the execution of the rules causes the data to be sorted into the appropriate fields of the electronic form.

In another example, the subset of rules may be for generating a user interface. The user interface may include a dialog box for presenting information for a subject matter expert end user. The data object may also contain the information and instructions for presenting the information in the dialog box on the end user's display device. The data object may also include instructions for establishing a communication link between the end user's user device and the user's user device (i.e., the data object may include instructions for placing the user device of the user who generated the query in communication with the user device of the subject matter expert determined to be likely to help the user). The data object may include a list of electronic form errors for presentation to the user, the end user, or both. The data object may include a copy of the electronic form for rendering by the user device of the user, the end user, or both. Many other examples are possible, as the output data object is a data construct created specifically to address the user's query.

Step 214 includes returning the output data object. The output data object may be returned according to many different procedures, depending on the purpose for which the data object was constructed. Some examples include returning the output data object by presenting the output data object to the user, or by converting the output data object to a user interface and presenting the user interface to the user. The output data object may be returned by executing an algorithm on the output data object and adding an output of the algorithm as an entry on the electronic form. The output data object may be returned by storing the output data object. The output data object may be returned by transmitting the output data object to an automated process.

Many other methods for returning the output data object are envisioned, as the rules and data that make up the output data object may change how the output data object is returned. Thus, one or more embodiments are not limited by the examples given herein.

The method of FIG. 2 may be varied. For example, the order of execution of the steps of FIG. 2 may be changed in some embodiments. In some embodiments, one or more steps may be removed, or other steps may be added.

For example, the method of FIG. 2 also may include generating the data file prior to receiving the user query. The data file may be generated by subject matter experts that specify the rules, subsets of data, user intent, and data schema that should be applied to the output of the rules. For example, a spreadsheet may be built which enters a specific rule in a row, with subsets of data to be used with that rule, the intent of the user, and the data schema. However, other data files are envisioned, such as a graph database which uses rules and data sets as nodes and user intent and schema as edges.

The method of FIG. 2 also may include updating the data file based on at least one of an identity of the user, the context topic, and the prediction text. In this case, updating is performed prior to applying the prediction text and the data sets to the data file. For example, if the user is identified as being an expert user, then the data file may be updated (or a different data file may be applied). The updated or different data file may have different rules and different data sets available for the expert user. Similarly, the context topic or the prediction text may influence how the data file is updated, or which data file should be used during the method of FIG. 2.

The method of FIG. 2 also may include selecting, prior to generating the prediction text and the data sets to the data file, the data file from among data files. Selecting is based on the prediction text and the data sets. It is possible to use multiple data files, each data file applicable to a different type of situation. For example, if the intent of the user is to clarify how an entry in the electronic form should be determined, then a first data file with rules for processing text instructions (i.e. a subset of data) for filling out the electronic form may be selected. However, if the intent of the user is different, then some other data file may be used instead in order to generate a result most likely to address the user's intent.

In still another embodiment, the method of FIG. 2 may include identifying an error in the electronic form. At least one of the data sets relates to the error, or perhaps one of the subsets of rules applies to the error. In this case, the output data object may be structured to present to the user or a subject matter expert end user information about the error and suggestions for correcting the error. Alternatively, the error may be automatically corrected using the output data object. Still other examples are possible.

The following is a specific variation of the method of FIG. 2. The variation demonstrates one possible use for the output data object, which is generated in response to a user query. Specifically, the user is seeking help from a subject matter expert. In this case, the output data object is used to help guide the subject matter expert, and provide suggestions to the subject matter expert, for helping the user complete the electronic form.

The method includes receiving, from an end user, a user query regarding completion of an electronic form stored as a data object. The method then includes generating a context topic that describes a category of data relevant to the user query. The method then includes extracting, from disparate data sources, a data set that corresponds to the context topic. The method then includes applying a machine learning model to the user query and the data sets to generate a prediction text representing a predicted intent of the end user.

The method then includes applying, to generate a subset of rules and a data schema, the prediction text and the data sets to a data file including rules and data schema applicable to the rules. The subset of rules is included in the rules and the data schema is included in the data schema. The data schema defines an output format of an output data object generated when the subset of rules is executed.

The method then includes determining, based on the subset of rules, a subset of the data sets. The method then includes applying the subset of rules to the subset of the data sets to generate the output data object. The output data object is formatted according to the data schema. The output data object describes information that is both related to completion of the electronic form and relevant to the predicted intent.

The method then includes generating a user interface using the output data object. The method then includes presenting the user interface on a display device of a helper user. The method then includes establishing a communication link between the helper user and the end user. Thus, the subject matter expert is placed in contact with the user, and also the subject matter expert is provided with automatic suggestions for solving the user's problem with the electronic form.

While the various steps in the flowchart of FIG. 2 are presented and described sequentially, at least some of the steps may be executed in different orders, may be combined or omitted, and at least some of the steps may be executed in parallel. Furthermore, the steps may be performed actively or passively.

FIG. 3 shows an alternative architecture for an improved query execution method for electronic form completion. FIG. 3, therefore, is a variation of the computing system shown in FIG. 1.

A user query (302) regarding an electronic form is received from a user device (300). The user query (302) is received at an orchestration service (304). The orchestration service (304) processes the user query (302) and determines which data sets (306) would be applicable to the user query (302). The orchestration service (304) identifies a data file (308) that contains the rules, schema, etc., that may be used to generate an output data object.

The orchestration service (304) may call a machine learning model (310), which in this example is a large language model. The input to the machine learning model (310) is the user query (302) and at least identifiers of the data sets (306). The output of the machine learning model (310) is a prediction text (312), which reflects an intent of the user with respect to the completion of an electronic form.

The prediction text (312) is provided to a runtime platform (314), which is configured to apply the prediction text and the data sets (or the identities of the data sets) to the data file to generate a subset of rules and the data schema. The runtime platform (314) also determines, based on the subset of rules, the subset of data sets. The runtime platform (314) also applies the subset of rules to the subset of data sets to generate the output data object.

The output data object may be returned to an end user device (318). The end user device may use the output data object (316) to generate a user interface which contains suggestions for a subject matter expert for how to help the user of the user device (300). The output data object (316) also may place the end user device (318) in communication with the user device (300) that submitted the user query (302).

Alternatively, the output data object (316) may be returned to the user device (300). In this case, the output data object (316) may instruct the user device (300) to display instructions for completing the electronic form. The output data object (316) may also include instructions for completing the electronic form directly on the user device.

In yet another alternative, the output data object (316) may be provided to a form service (320). The form service (320) may then use the data, and other instructions, contained in the output data object (316) to complete, at least partially, the electronic form.

FIG. 4 shows an example of an improved query execution method for electronic form completion, in accordance with one or more embodiments. The following example is for explanatory purposes only and not intended to limit the scope of one or more embodiments.

A user (400), Adam, is preparing Adam's tax forms using an online tax preparation service that uses electronic tax forms. Adam has encountered an error and does not know how to solve the error. Thus, Adam uses a widget on the online tax preparation service's user interface to be placed in contact with a tax expert. However, it is desirable that the tax expert be provided with specific information for helping Adam, rather than spending time becoming more familiar with Adam's problem.

When Adam selects the widget, Adam is prompted to describe Adam's problem. Adam writes, in user query (402), “what's wrong with my tax form?” Note that the intent of Adam's query is important to answering the question. If Adam were asking about tax forms generally, one answer would be generated. A different answer may be generated if Adam were asking about a technical problem with the electronic tax form itself. Yet a different answer may be generated if Adam were having trouble filling out the electronic tax form because Adam made an inadvertent and unknown error in data entry.

Thus, the user query (402) is provided to an orchestration service (404). The orchestration service (404) determines the identity of the form related to Adam's user query (402) based on the form Adam had been working on (i.e. “my form”) at the time the user query (402) was submitted. The orchestration service (404) determines that three different data sources may be involved, including data source A (406) (Adam's user data), data source B (408) (form instructions for filling out the electronic tax form), and data source C (410) (reference tables needed to perform calculations called for by the electronic tax form).

The orchestration service (404) then calls a machine learning model (412) in order to determine Adam's intent. The user query (402) and the identities of the data sets are provided as input to the machine learning model (412). The machine learning model (412) outputs a prediction text (414) which represents a computer prediction of the intent of Adam's query. Here, the machine learning model (412) predicts that the intent of the user query (402) is to solve a data entry problem. In other words, Adam does not understand some aspect of the electronic tax form, or Adam has made an error in one of the boxes of the electronic tax form. In other words, the predicted intent is that Adam is having trouble correctly filling out the electronic tax form.

The system stores a data file (416). The data file (416) contains rules and output schema for a variety of different situations.

A runtime platform (418) receives the prediction text (414) and the identities of the data sets. The runtime platform (418) applies the prediction text (414) and the identities of the data sets to the data file (416) to generate a subset of rules within the data file (416) that are applicable to Adam's user query (402). The runtime platform (418) also identifies specific subsets of data within the data source A (406), the data source B (408), and the data source C (410) that may be useful in resolving Adam's user query (402). The runtime platform (418) also determines, using the data file (416), the data schema that the resulting output data object (420) should have.

Once the subset of rules, the subsets of data, and the schema are determined, the runtime platform (418) executes the subset of rules on the subsets of data. The resulting output is formatted in the schema and output into the output data object (420).

In this example, the output data object (420) includes instructions for presenting a user interface (422) to a tax expert. The instructions will cause the user interface (422) to display to the tax expert a copy of the electronic tax form that Adam is working on, and to highlight the fields on the form with which Adam is having difficulty. The instructions will also cause the user interface to display or reference for the tax expert those relevant regulations and instructions for processing the electronic form, and specifically those regulations and instructions pertaining to the fields with which Adam is having difficulty. Finally, the output data object (420) contains instructions for establishing a communication link (424) between the tax expert's user device and Adam's user device.

The tax expert then, with the relevant information already at the tax expert's fingertips, generates a response (426) on the tax expert's user device. The response (426) is, “I can see the problem with your form, I can help.” The response (426) is communicated via the communication link (424) back to Adam's user device. Adam's problem with the electronic tax form is resolved shortly thereafter.

Note that the example of FIG. 4 could be varied. For example, the output data object (420) may contain instructions for automatically filling out Adam's electronic tax form. In this case, a suite of software (a form service) may use the output data object (420) to automatically complete Adam's electronic tax form. Again, Adam's problem with the electronic tax form is resolved.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 5A, the computing system (500) may include one or more computer processor(s) (502), non-persistent storage device(s) (504), persistent storage device(s) (506), a communication interface (508) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) (502) may be one or more cores or micro-cores of a computer processor. The computer processor(s) (502) includes one or more processors. The computer processor(s) (502) may include a central processing unit (CPU), a graphics processing unit (GPU), a tensor processing unit (TPU), combinations thereof, etc.

The input device(s) (510) may include a touchscreen, keyboard, mouse, microphone, touchpad, electronic pen, or any other type of input device. The input device(s) (510) may receive inputs from a user that are responsive to data and messages presented by the output device(s) (512). The inputs may include text input, audio input, video input, etc., which may be processed and transmitted by the computing system (500) in accordance with one or more embodiments. The communication interface (508) may include an integrated circuit for connecting the computing system (500) to a network (not shown) (e.g., a local area network (LAN), a wide area network (WAN) such as the Internet, mobile network, or any other type of network) or to another device, such as another computing device, and combinations thereof.

Further, the output device(s) (512) may include a display device, a printer, external storage, or any other output device. One or more of the output devices may be the same or different from the input device(s) (510). The input and output device(s) may be locally or remotely connected to the computer processor(s) (502). Many different types of computing systems exist, and the aforementioned input and output device(s) may take other forms. The output device(s) (512) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (502), is configured to perform one or more embodiments, which may include transmitting, receiving, presenting, and displaying data and messages described in the other figures of the disclosure.

The computing system (500) in FIG. 5A may be connected to or be a part of a network. For example, as shown in FIG. 5B, the network (520) may include multiple nodes (e.g., node X (522), node Y (524)). Each node may correspond to a computing system, such as the computing system shown in FIG. 5A, or a group of nodes combined may correspond to the computing system shown in FIG. 5A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522), node Y (524)) in the network (520) may be configured to provide services for a client device (526), including receiving requests and transmitting responses to the client device (526). For example, the nodes may be part of a cloud computing system. The client device (526) may be a computing system, such as the computing system shown in FIG. 5A. Further, the client device (526) may include or perform all or a portion of one or more embodiments.

The computing system of FIG. 5A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
receiving a user query of a user, wherein the user query relates to completion of an electronic form stored as a data object;
generating a context topic that describes a category of data relevant to the user query;
extracting a plurality of data sets that correspond to the context topic;
applying a machine learning model to the user query and the plurality of data sets to generate a prediction text representing a predicted intent of the user;
applying, to generate a subset of rules and a data schema, the prediction text and the plurality of data sets to a data file comprising a plurality of rules and a plurality of data schema applicable to the plurality of rules, wherein:
the subset of rules is included in the plurality of rules and the data schema is included in the plurality of data schema, and
the data schema defines an output format of an output data object generated when the subset of rules is executed;
determining, based on the subset of rules, a subset of the plurality of data sets;
applying the subset of rules to the subset of the plurality of data sets to generate the output data object, wherein:
the output data object is formatted according to the data schema, and
the output data object describes information that is both related to completion of the electronic form and relevant to the predicted intent; and
returning the output data object.

2. The method of claim 1, wherein generating the context topic comprises:
identifying a section of the electronic form related to the user query, and
wherein the category of data is relevant to the section of the electronic form.

3. The method of claim 1, wherein extracting comprises:
identifying, based on the context topic, a plurality of disparate data sources that contain the plurality of data sets;
performing, via a data integration service, a plurality of separate application programming interface calls to the plurality of disparate data sources;
receiving the plurality of data sets; and
aggregating the plurality of data sets into a vector data structure configured for use as input to the machine learning model.

4. The method of claim 3, wherein applying the machine learning model to the user query and the plurality of data sets comprises:
converting the user query into a vector format; and
adding the user query to the vector data structure.

5. The method of claim 1, wherein the data file comprises a spreadsheet, and wherein applying the prediction text and the plurality of data sets to the data file further comprises:
selecting, based on the prediction text and the plurality of data sets, the subset of rules from among the plurality of rules,
wherein the spreadsheet specifies the data schema.

6. The method of claim 1, wherein determining the subset of the plurality of data sets comprises at least one of:
executing the subset of rules on the plurality of data sets to determine the subset of the plurality of datasets; and
selecting the subset of the plurality of data sets based on identities of the subset of rules.

7. The method of claim 1, wherein applying the subset of rules to the subset of the plurality of data sets comprises:
executing the subset of rules on input from the subset of the plurality of data sets; and
formatting the data object according to the data schema.

8. The method of claim 1, wherein returning the output data object comprises at least one of:
presenting the output data object to the user;
converting the output data object to a user interface and presenting the user interface to the user;
executing an algorithm on the output data object, and adding an output of the algorithm as an entry on the electronic form;
storing the output data object; and
transmitting the output data object to an automated process.

9. The method of claim 1, further comprising:
generating the data file prior to receiving the user query.

10. The method of claim 1, further comprising:
updating the data file based on at least one of an identity of the user, the context topic, and the prediction text,
wherein updating is performed prior to applying the prediction text and the plurality of data sets to the data file.

11. The method of claim 1, further comprising:
selecting, prior to generating the prediction text and the plurality of data sets to the data file, the data file from among a plurality of data files,
wherein selecting is based on the prediction text and the plurality of data sets.

12. The method of claim 1, further comprising:
identifying an error in the electronic form,
wherein at least one of the plurality of data sets relates to the error.

13. The method of claim 1, further comprising:
identifying an error in the electronic form,
wherein at least one of the plurality of data sets relates to the error, and
wherein at least one of the subset of rules relates to the error.

14. A method comprising:
receiving, from an end user, a user query regarding completion of an electronic form stored as a data object;
generating a context topic that describes a category of data relevant to the user query;
extracting, from a plurality of disparate data sources, a plurality of data sets that correspond to the context topic;
applying a machine learning model to the user query and the plurality of data sets to generate a prediction text representing a predicted intent of the end user;
applying, to generate a subset of rules and a data schema, the prediction text and the plurality of data sets to a data file comprising a plurality of rules and a plurality of data schema applicable to the plurality of rules, wherein:
the subset of rules is included in the plurality of rules and the data schema is included in the plurality of data schema, and
the data schema defines an output format of an output data object generated when the subset of rules is executed;
determining, based on the subset of rules, a subset of the plurality of data sets;
applying the subset of rules to the subset of the plurality of data sets to generate the output data object, wherein:
the output data object is formatted according to the data schema, and
the output data object describes information that is both related to completion of the electronic form and relevant to the predicted intent;
generating a user interface using the output data object;
presenting the user interface on a display device of a helper user; and
establishing a communication link between the helper user and the end user.

15. A system comprising:
a computer processor;
a data repository in communication with the computer processor and storing:
a user query of a user, the user query relating to completion of an electronic form stored as a data object,
a context topic that describes a category of data relevant to the user query,
a plurality of data sets that correspond to the context topic,
a prediction text representing a predicted intent of the user,
a data file comprising a plurality of rules and a plurality of data schema applicable to the plurality of rules,
a subset of rules and a data schema, wherein the subset of rules is included in the plurality of rules and the data schema is included in the plurality of data schema, and wherein the data schema defines an output format of an output data object generated when the subset of rules is executed,
a subset of the plurality of data sets, and
the output data object, wherein the output data object is formatted according to the data schema and the output data object describes information that is both related to completion of the electronic form and relevant to the predicted intent;
an orchestration service programmed, when executed by the computer processor, to:
receive the user query,
generate the context topic based on the user query,
extract the plurality of data sets from a plurality of disparate data sources, and
return the output data object;
a machine learning model trained, when executed by the computer processor, to predict the prediction text from the user query and the plurality of data sets; and
a runtime platform programmed, when executed by the computer processor, to:
apply the prediction text and the plurality of data sets to the data file to generate the subset of rules and the data schema,
determine, based on the subset of rules, the subset of the plurality of data sets, and
apply the subset of rules to the subset of the plurality of data sets to generate the output data object.

16. The system of claim 15, further comprising:
a training controller programmed, when executed by the computer processor, to train the machine learning model by iteratively performing, until convergence:
receiving a training data set comprising a plurality of user queries regarding completion of a plurality of electronic forms, a corresponding plurality of context topics, and pluralities of data sets describing to the corresponding plurality of context topics,
predicting a plurality of intermediate prediction texts representing predicted intents of the plurality of user queries,
comparing the plurality of intermediate prediction texts to known user intents of the plurality of user queries,
generating loss functions based on differences between the plurality of intermediate prediction texts and known user intents, and
modifying the machine learning model based on the loss functions.

17. The system of claim 15, further comprising:
at least one of the plurality of disparate data sources.

18. The system of claim 15, further comprising:
a user interface generator programmed, when executed by the computer processor, to convert the output data object to a user interface; and
a user device for presenting the user interface to the user.

19. The system of claim 18, further comprising:
a communication interface operable to establish a communication link between the user interface and an end user device of an end user.

20. The system of claim 15, further comprising:
a form service programmed, when executed by the computer processor, to modify the electronic form based on the output data object.
